(19) United States
(12) Patent Application Publication
(10) Pub. No.: US 2009/0212952 A1
(43) Pub. Date: Aug. 27, 2009

(54) METHOD AND APPARATUS FOR DE-ACTIVATING EAS MARKERS

(76) Inventor: Xiao Hui Yang, Los Altos, CA (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 12/391,215

(22) Filed: Feb. 23, 2009

Related U.S. Application Data
(60) Provisional application No. 61/030,927, filed on Feb. 22, 2008.

(51) Int. Cl. G08B 13/22

(52) U.S. Cl. 340/572.3

(57) ABSTRACT

A method and apparatus for deactivating magnetomechanical EAS sensors is disclosed and claimed. The apparatus features an improved deactivation performance at a reduced cost by orienting at least one pair of deactivation coils such that the coils create a composite magnetic field that is stronger in the areas of the deactivation surface most likely to be utilized. The system is further arranged such as to reduce the composite magnetic field in other areas of the deactivation surface less likely to be needed, thereby lowering total power use and increasing effectiveness of the system. The deactivator further features monitoring means for detecting the presence of sensors, and for adjusting the composite magnetic field in response to system effectiveness.

### CROSS REFERENCE TO RELATED APPLICATIONS

This application claims priority from U.S. Provisional Application 61/030,927, filed on Feb. 22, 2008, and the teachings in the specification for the provisional application are incorporated herein by reference.

### FIELD OF THE INVENTION

This invention relates generally to a method and apparatus for deactivating EAS acoustomagnetic markers, such as labels and tags. More specifically, the method and apparatus relate to utilizing magnetic fields created by energizing coils to deactivate electronic article surveillance markers.

### BACKGROUND

In the retail sales sector, theft is a major issue, particularly, theft by shoplifting. One method of dealing with this issue is to place electronic article surveillance (EAS) markers on the merchandise being sold. Antennas are placed at the exits and entrances to the retail location, and these antennas set up zones, sometimes referred to as interrogation zones, in which a marker may be sensed.

At least some of these antennas send out what is called an interrogation signal. The markers on the merchandise are affected by this signal and will respond with a signal of their own. Either the same antennas that send out the interrogation signals or other additional antennas can sense the signals from the markers. The most effective way to do this is by stopping the broadcast of the interrogation signal to listen for the signals emanating from the markers. If a marker is sensed within the zone created by the antennas, it is presumed that an article is being removed without purchase, and alarms are set off. These alarms may be audible alarms for general broadcast or the alarms may be silent alarms in the form of a light at a check-out counter or security station, etc.

Several types of tags or labels can be used and attached to the merchandise. These markers may be classified as active or passive. Active markers have an on-board power source, such as a battery, and are capable of sensing the interrogation signal in an interrogation zone and responding with a signal of their own. The monitoring antennas in this type of system will be tuned to the frequency at which the markers are designed to respond. Passive markers have electronic circuitry onboard which are energized by the interrogation signal and respond at a frequency related to the interrogation signal. Some passive markers have an inductor and capacitor hooked together in series. These types of tags will respond at a frequency that is a multiple, or harmonic, of the interrogation frequency. The circuit is energized at a low level by the interrogation signal, and once the interrogation signal is removed, the energy stored in the circuit is dissipated. In the process, the circuit releases a signal at a multiple of the interrogation signal frequency. Another type of passive marker is tuned to have a resonant frequency at the frequency of the interrogation signal. This type of label marker has two thin metallic strips within it. One of those metallic strips has the characteristic of low magnetic coercivity. The metallic strip having a low magnetic coercivity is magnetized and the relationship of the two metallic strips is tuned so that the non-magnetic strip has a resonant response to the interrogation signal. This means that when the interrogation signal is stopped, the label will send back a signal at the same frequency as the interrogation signal, while it discharges energy received from the interrogation signal.

The passive markers that use two metallic strips, one of which is magnetized, can be deactivated by demagnetizing the magnetized strip. This alters the resonant frequency of the label away from the interrogation signal frequency, and therefore the reaction of the metallic strips is too weak to cause a reaction by the monitoring system. The labels may be deactivated by exposure to a magnetic field having reciprocating magnitudes at a high enough level to cause saturation in the magnetic strip and then attenuating the magnetic field down to zero. This is accomplished by electrically driving at least one coil while passing the label near the coil. The current running through the at least one coil generates a magnetic field. Magnetic fields generated in this fashion have directional qualities, which is to say that they are stronger along some lines than other lines. Also, distance from the generating coil or coils, will decrease the strength of the magnetic field. In particular, a magnetic field will be most effective to deactivate a magnetomechanical tag if the metal strips are aligned with the direction of greatest strength of the magnetic field. A tag which has its longest dimension across the direction of greatest strength of the magnetic field will not be as certain to be deactivated or as fully deactivated.

Many commercially available EAS systems operate on a frequency of 58,000 Hertz (58 kHz). For a deactivator system to effectively deactivate labels and tags operating at this frequency, the deactivator coils must utilize a relatively high amount of power. Power use by the deactivator coils can become a considerable expense for the retailer, and it is generally desirable to reduce power consumption of the deactivation coils without compromising the effectiveness of the deactivator.

In general, deactivation is achieved by locating the deactivation coils in the checkout counter of the retail establishment. The checkout counter is generally a flat table-like surface and work space in the area of the checkout counter and is valuable space for the retailer. A retail employee will be standing or seated in front of the checkout counter and the employee's hands will contact the checkout counter surface throughout the day in the normal execution of work duties. For this reason, the buildup of heat on the counter is undesirable. Heat buildup may also be undesirable since the checkout counter vicinity may include items desired for impulse consumption such as chocolates and the like. The deactivator coils are built into the counter such as to be fully encased, and the buildup of heat over time reduces the operating life of the deactivator. For these additional reasons, it is desirable to reduce the power level of the deactivation coils in order to reduce the heat generated by the system.

The normal work habits of retail employees generally results in the employee deactivating the EAS label/tag by “scanning” the merchandise which normally takes the form of sliding the merchandise horizontally across the counter. The path of travel is typically the same for most items being scanned. The center area of the counter is the most likely location for orientation of the package during scanning. Given this predicable route, the deactivation exercise may be enhanced by boosting power at the counter locations most likely to be utilized during scanning. Yet, in order to reduce heat and power consumption, the deactivation signal strength for other portions of the counter could and should be reduced. Plus, it would be advantageous to localize the strength of the deactivation magnetic field in some regions of the counter while reducing the strength of the deactivation magnetic field in other areas of the counter.

### DESCRIPTION OF RELEVANT ART

U.S. Pat. No. 5,905,435 by Copeland et. al. is for a deactivator having at least three coils arranged in a coplanar fashion. The deactivator in Copeland '435 is for deactivating acousto-magnetic markers having two strips of metal, one of which is a biasing strip for tuning the electromagnetic response of the tag. The at least three coils in Copeland '435 are electrically connected in series. The three coils are generally arranged in a triangular fashion with two of the coils being of the same size as each other but smaller than the size of the third coil. The two smaller coils are arranged nearly adjacent to each other, and the third coil is arranged so that its center lies on the perpendicular bisector of the line running from the center of the first smaller coil to the center of the second smaller coil. The serial connection of the coils is arranged so that they are out of phase with each other when powered. The two smaller coils are out of phase with each other. In another embodiment of the Copeland '435 deactivator, if the third coil is not larger than the first two coils, then a fourth coil is added. In the four coil embodiment, the fourth coil has its center on the same perpendicular bisector of the line running between the two centers of the small coils. This results in a “T” arrangement of the four coils.

U.S. Pat. No. 5,867,101 by Copeland, et al. discloses embodiments of a deactivator that uses two coplanar flat coils and four coplanar flat coils. The embodiment using two coplanar flat coils drives the coils in two different modes. In a first mode, the coils are driven in phase which creates a magnetic field having its strongest lines of force substantially perpendicular to the plane of the coils up into the effective deactivation field. The second mode is out of phase so that in the effective deactivation field, the strongest lines of force in the magnetic field are parallel to the plane in which the coils lie and perpendicular to the previously mentioned magnetic field. This last magnetic field also has its lines of strength directed parallel to the line which would run through the center of both coils. The deactivator works by using a detecting circuit which finds a tag in proximity to the deactivator, and then energizes the deactivation coils in a first mode for a brief period. This activation is ceased and then the deactivation coils are energized in a second mode. These two cycles are interleaved for a set period determined to be long enough to deactivate a marker found in the deactivation zone.

The embodiments of Copeland '101 using four coils place the four coils in a square coplanar arrangement. In a first mode, all four of the coils are energized in phase with each other and this produces a magnetic field having its strongest lines of force perpendicular to the plane of the coils. In a second mode, the top coils are energized in phase with each other, but out of phase with the bottom two coils which are energized in phase with each other. This produces a magnetic field having its strongest lines of force parallel to the plane of the coils and running in the direction from the top two coils to the bottom two coils. In a third mode of operation, the left two coils are energized in phase with each other but out of phase with the right two coils which are energized in phase with each other. This produces a magnetic field having its strongest lines of force parallel to the plane of the coils and running left to right. This gives the deactivation coils the ability to alternately create fields in the three cardinal directions. The control circuit used to drive the coils takes in standard AC power, uses a controller in conjunction with a phase shifter and switches to vary the phase of the coils to generate the different modes of operation of the coils.

U.S. Pat. No. 5,142,292 by Chang claims an electronic article surveillance tag deactivator, having four antenna loops connected in series and arranged coplanarly. The four antenna loops are arranged in a two-by-two array, and the loops are connected in such fashion that each adjacent loop will be out of phase with the two loops next to it. This is intended to keep the magnetic field produced by the loops from extending too far from the plane of the loops. The type of tag that Chang is meant to deactivate is the type having a capacitor element. The deactivation is accomplished by overloading the circuit with a charge generated by a magnetic field, and the overload shorts between the capacitor plates, permanently altering the response frequency tag.

### SUMMARY

A method and apparatus is disclosed for deactivating magnetomechanical EAS markers in a retail setting. The method and deactivator apparatus use at least two coils, and seeks to maximize the strength of the magnetic field in the physical area where it is needed the most, while minimizing overall power consumption. The two coils are placed in a coplanar relationship with each other and connected serially in near proximity to each other. The serial connection is accomplished in such fashion that the coils are out of phase with each other when a current is passed through them. The coils are located in close enough proximity to each other that their electromagnetic fields influence and shape each other and this out-of-phase operation creates a magnetic field shaped to adhere more closely to the plane of the coils than the magnetic field generated by coils operated in phase with each other. To deactivate a marker, a controller energizes the coils while the marker is passed through the magnetic field generated by the coils. The magnetic field generated by the deactivation coils starts at a given alternating magnitude and attenuates to nearly zero which demagnetizes the bias strip in a magnetomechanical label. The coils may be energized more than once in quick succession while the marker is being passed near the coils. A person of ordinary skill in the art would understand how to arrange a controller and/or a control circuit to accomplish the generation of the field.

In one embodiment of the apparatus disclosed herein, the deactivator is oriented such as to anticipate the regular and expected mode of operation for the deactivation cycle. The deactivation coils are built into the counter top at the retail checkout counter. Some regions of the retail counter correspond to the areas of highest use by employees in “scanning” merchandise for deactivation. It is important that a sufficiently strong composite magnetic field be present at this optimal region of use, and the orientation of the electrical coils is designed to do just that. Thus, the orientation of the coils within the counter can be physically made in such a way as to enable the strongest composite magnetic field to occur at these regions of most likely scanning use. Likewise, regions of little use for deactivation can feature a reduced magnitude of the composite magnetic field in order to save energy without compromising deactivator performance.

In another embodiment, a marker detection component may be added. This component may use a transmitter coil along with a receiver coil or a transceiver coil to perform both functions. The detection component generates an interrogation field and then stops the generation of the interrogation field to “listen” for a signal from a marker. If the marker is sufficiently close to be energized by the field, generate a signal, and be detected by the detection component, the deactivation coils energize to generate a deactivation field. In an embodiment using a transmitting coil and a receiving coil, the transmitting coil generates the interrogation field while the receiving coil performs the listening function. In an embodiment using a transceiver coil, the transceiver coil performs both functions sequentially. A person of ordinary skill in the art would understand how to arrange a controller and/or a control circuit to accomplish the detection of the tag.

In another embodiment, the deactivation system is designed to monitor deactivation performance in order to alter the power delivery to the electrical coils in such a way as to alter the strength of the composite magnetic field in order to provide acceptable levels of performance while minimizing cost as much as practical.

In another embodiment, the deactivating magnetic field may be generated multiple times after the detecting component re-checks for the presence of the tag. After the detecting component initially detects the tag, the deactivating field is generated. The detecting component then checks again for the presence of an active tag. If the tag is still detected, the deactivating field is generated again. This cycle may be repeated until the tag is no longer detected, which indicates that the tag has been deactivated.

In other embodiments, additional sets of two-coil pairs are used. In each set, the coils are connected in series electrically with each other, but the sets are connected in parallel with the other sets. The coils in each set may be arranged so that they operate out of phase with each other. The presence of additional sets of two coils allows the magnetic deactivation field to be easily expanded and shaped to the desired area of deactivation. The out-of-phase operation of the coil sets keeps the magnetic deactivation field closer to the plane of the coils. The combination of sets of coils in parallel in a circuit would change the impedance of the circuit, which affects the settings and the sizing of components in the control circuitry. A person of ordinary skill in the art would understand how to arrange a controller and/or a control circuit to accomplish the generation of the field.

In other embodiments, a detection component is associated with each set of two deactivation coils. This allows the detection field to closely match that of the deactivation field. A person of ordinary skill in the art would understand how to arrange a controller and/or a control circuit to accomplish the generation of the detection and deactivation fields.

### BRIEF DESCRIPTION OF THE DRAWINGS

Additional utility and features of the invention will become more fully apparent to those skilled in the art by reference to the following drawings, which illustrate the primary features of the preferred embodiment.

FIG. 1 shows two deactivation coils of one embodiment of the invention, and the current flow in those coils during operation for that embodiment.

FIG. 2A shows two coils of an embodiment in which the current flows are in opposite directions, or out of phase with each other, and their current flow in that embodiment while in operation.

FIG. 2B shows the directional lines of the composite magnetic field generated while the coils of FIG. 2A have current flowing through as shown in FIG. 2A.

FIG. 3A shows an arrangement of two coils, operating in phase with each other and the current flow associated with such an arrangement.

FIG. 3B shows the directional lines of the composite magnetic field generated by operating the coils of FIG. 3A in phase with each other.

FIG. 4 shows the amplitude characteristic of a magnetic field generated to deactivate magnetomechanical tags.

FIG. 5 shows an embodiment having a monitoring component comprising a transmitter coil and a receiver coil.

FIG. 6 shows an embodiment having a monitoring component comprising a transceiver coil.

FIG. 7 shows an embodiment having a deactivation component comprising two sets of coils electrically in parallel.

FIG. 8 shows an embodiment having a deactivation component comprising two sets of coils driven separately.

FIG. 9 shows an embodiment having a deactivation component comprising three sets of coils electrically in parallel.

FIG. 10 shows an embodiment having a deactivation component comprising three sets of coils driven separately.

FIG. 11 shows an embodiment of the deactivator apparatus located in a counter.

### DETAILED DESCRIPTION OF EMBODIMENTS

The detailed description below is for embodiments intended to illustrate and explain the current invention. It is to be understood that a variety of other arrangements are also possible without departing from the spirit and scope of the invention. Where appropriate, the same numbering will be used when discussing different embodiments.

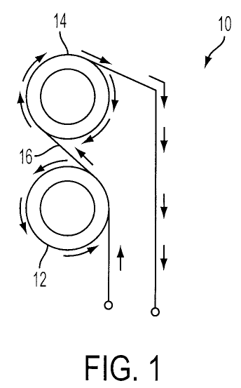

Referring to FIG. 1, which described one embodiment of the invention, the method and apparatus 10 use at least two coplanar coils in near proximity to each other. A first coil 12 is serially connected to a second coil 14 at connection 16. Connection 16 may be integral to the winding of coils 12 and 14 or may be accomplished by any of the means common to electrical circuitry. The connection 16 is accomplished in such fashion that coils 12 and 14 are out of phase with each other when a current is passed through them. Arrows in FIG. 1 indicate the relative flow of current in coils 12 and 14. Of course, if the current is reversed, the current will flow in the opposite direction throughout.

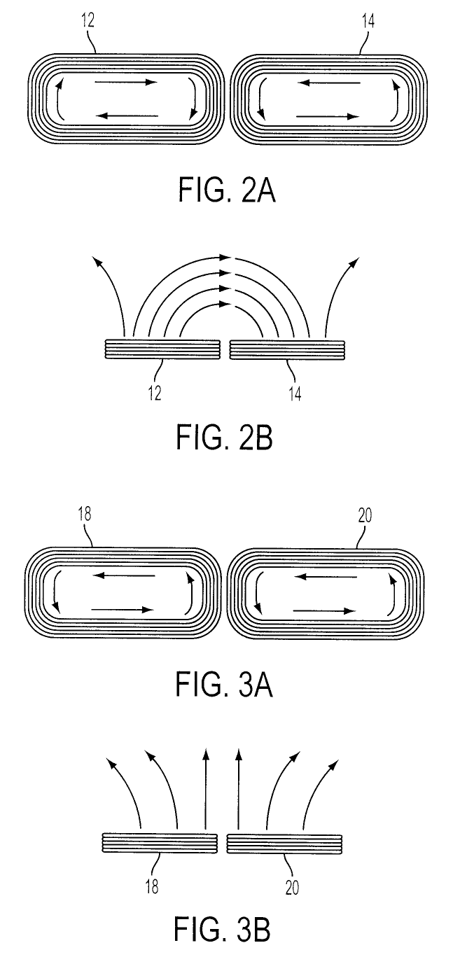

FIG. 2A again shows a top view of first coil 12 and second coil 14 and the relative flow current in the coplanar, serial, out of phase coils 12 and 14. FIG. 2B is a side view of coils 12 and 14 from the top edge of the figures. The arrows in FIG. 2B show the directional lines of force of the magnetic field as generated by coils 12 and 14 when operated out of phase with each other. As can be seen in FIG. 2B, coils 12 and 14 are operating out of phase with each other and produce a magnetic field having its lines of force directed from one coil to the other. This keeps the magnetic field relatively closer to the plane of the coils and more tightly contained. This reduces the unwanted effects of the magnetic field in an extended range. This also provides a very strong field in the area of where the coils are in close proximity to each other. When this region is designed to correspond to the area of most likely use for retail scanning, deactivation performance can be improved at a lower power cost.

FIG. 3A shows two coils, coils 18 and 20, being operated in phase with each other as indicated by the arrows showing the direction of current flow. FIG. 3B is a side view of coils 18 and 20 from the bottom of the FIG. 3A. The arrows in FIG. 3B show the lines of force in the magnetic field generated by the in-phase operation of coils 18 and 20. Two coils in close proximity and operated in phase with each other will generate a magnetic field very similar to a magnetic field generated by a single coil of similar power capabilities. As the arrows in FIG. 3B show, the magnetic field projects more from the plane of coils 18 and 20 than the magnetic field shown in FIG. 2B and generated by the out-of-phase operation of coils 12 and 14.

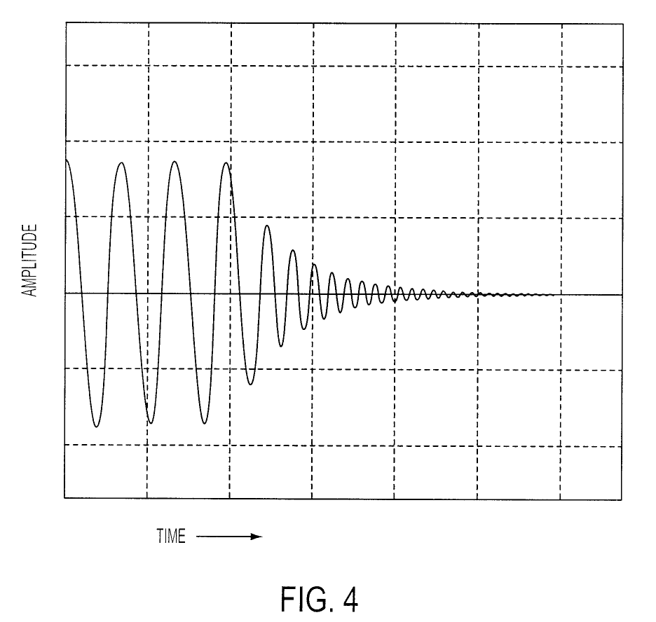

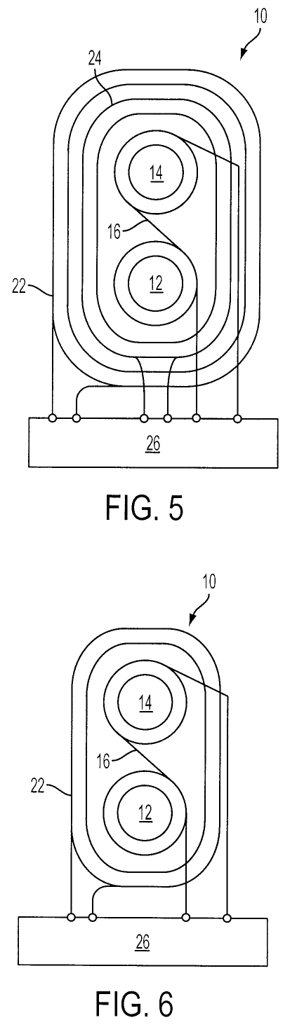

FIG. 4 shows the characteristics of a magnetic field typically generated to deactivate a magnetomechanical EAS tag. The magnetic field starts with an alternating amplitude of a given magnitude. It then “rings down”, or attenuates, to zero. A magnetic field having these characteristics will deactivate a magnetomechanical tag present in the field. Such a field may be generated by one or more coils.

In one embodiment of the invention, a magnetomechanical tag is deactivated by passing it near coils 12 and 14 while coils 12 and 14 are being driven by a control circuit. Coils 12 and 14, connected in electrical series, are operated out of phase to generate a magnetic field having the shape indicated in FIG. 2B and the magnitude characteristics shown in FIG. 4. The attenuating magnetic field deactivates the tag.

FIG. 5 shows a schematic of another embodiment. This embodiment allows a more automated operation of the apparatus and method. Coils 12 and 14 are present in this embodiment to generate a deactivation field. Coils 12 and 14 are coplanar, electrically serial, and operated out of phase with each other. Coil 22 generates an interrogation field, while coil 24 is a receiver coil capable of receiving signals from energized tags. Controls 26 coordinate the operation of the coils.

In operation, coil 22 generates an interrogation field strong enough to energize any tags in proximity and then stops. Receiver coil 24 monitors for signals from tags in proximity. When a tag signal is detected, coils 12 and 14 are energized by controls 26 to generate the deactivation field as discussed above. When the apparatus is turned on, the operation of the coils is automatic with coil 22 and 24 operating periodically to check for tags in proximity.

FIG. 6 shows another embodiment. In this embodiment coil, 22 is operated as a transceiver coil and a fourth coil such as coil 24 in FIG. 5 is not needed. Coil 22 both generates an interrogation field and monitors for the presence of tags. Coil 22 alternates performing these functions and controls 26 again coordinate the operation of the detection components of the apparatus and the deactivation components of the apparatus.

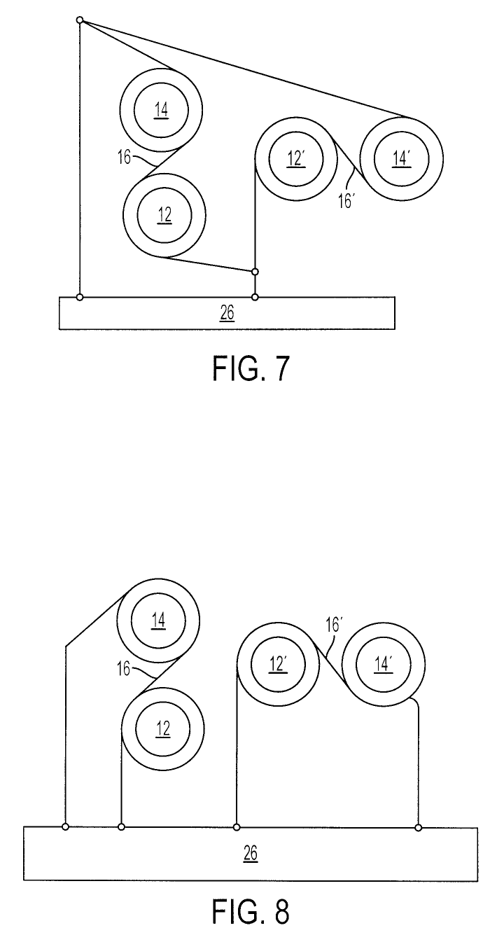

FIG. 7 shows deactivation components of another embodiment. Coils 12 and 14 are again connected in series with each other and operated out of phase with each other. Additionally, coils 12′ and 14′ are connected in series with each other and operated out of phase with each other. The two sets of coils, however, are electrically parallel with each other. Also the sets of coils 12 and 14 and coils 12′ and 14′ are coplanar. Controls 26 generates the same magnitude profile for the magnetic fields generated by each set of coils. The presence of the additional set of coils changes the impedance of the coil circuit. A person of ordinary skill in the art would know how to change settings and alter the size of components in controls 26 to create the desired field. The parallel arrangement of the coil sets allows for easy extension of the magnetic field along the plane of the coils for particular retail environments, different counters, etc. without increasing the amplitude of the magnetic field generated by a set of coils.

Alternatively, as shown in FIG. 8, the coil sets having coils 12 and 14 and coils 12′ and 14′ can be driven entirely separately by controls 26. The coils are still coplanar and out of phase with each other within the sets. The coils interact with each other electromagnetically to shape the magnetic field to adhere to the plane of the coils, but the sets are electrically separated from each other. In the embodiment shown in FIG. 8, variations in the timing of the activation of the coil sets could also be achieved by controls 26.

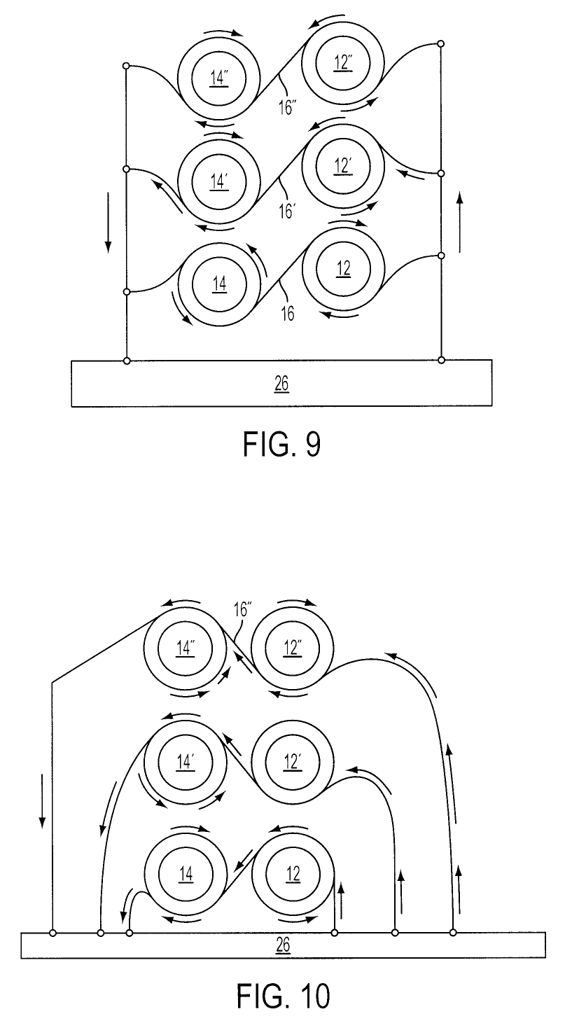

FIG. 9 shows another embodiment where three sets of coils are operated electrically in parallel with each of the coils in each of the sets being operated out phase with each other but electrically in series with each other. Again the coils are coplanar. Additional coils 12″ and 14″ add more magnetic field near the plane of the coils without requiring an increase in the magnitude of the magnetic field which would project further from the deactivation zone and be more likely to unintentionally affect nearby devices. The coil sets can be arranged so that each coil is out of phase with nearby coils, as is the case with the coil sets having coils 12 and 14 and coils 12′ and 14′, or the coil sets can be arranged so that some coils are in phase with some nearby coils, as is the case with the coil sets having coils 12′ and 14′ and coils 12″ and 14″ in FIG. 9.

The additional coil sets connected in parallel change the impedance of the coil circuit. Controls 26 are adjusted and sized to adapt to this change in impedance. A person of ordinary skill in the art would know how to accomplish this.

FIG. 10 shows coils set being driven separately by controls 26. This is in contrast to being driven in parallel. The coils sets containing coils 12 and 14, coils 12′ and 14′ and coils 12″ and 14″ are coplanar. Controls 26 are capable of altering the current flow in the sets so that while coils within coil sets will be out of phase with each other the coils in adjacent sets may or may not be out of place with each other depending on the field desired to be generated. Generally, having coils out of phase with neighboring coils produces a magnetic field adhering more closely to the plane of the coils. Controls 26 can also vary the timing of the activation of the coil sets depending on the application, etc.

Each of the embodiments of FIGS. 7-10 can also employ detection coils similar to the embodiments of FIGS. 5 and 6. The embodiments of FIGS. 7-10 can use an interrogation coil in conjunction with a receiving coil, or the embodiments of FIGS. 7-10 can employ a transceiver coil which alternately broadcasts an interrogation signal and scans for return signals. Additionally, a detection component can be located with each set of deactivation coils, or a single deactivation component can service the entire deactivation area. It is anticipated that most embodiments will operate with a single detection component.

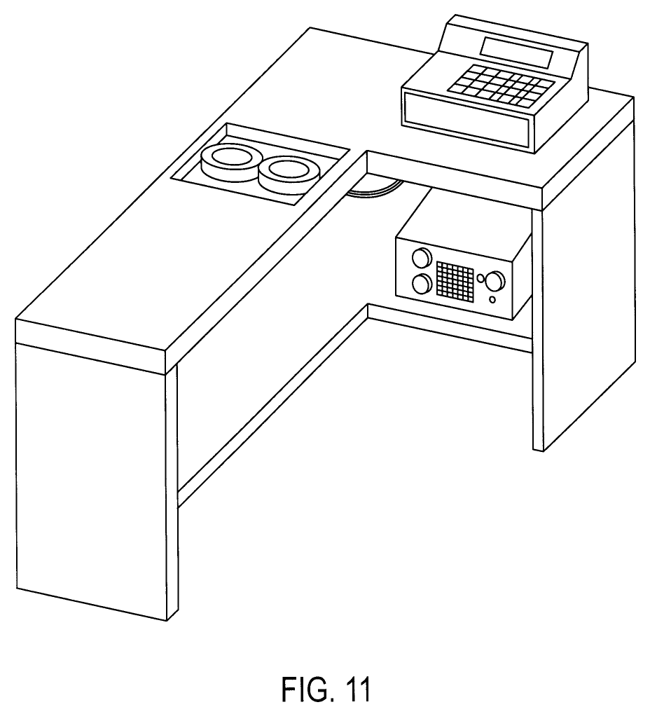

Most typically the deactivating apparatus will be located at a checkout counter in the retail store and will be used by an employee while checking goods out for a customer. A typical arrangement is shown in FIG. 11. This allows the tags on purchased items to be systematically deactivated so that a customer may remove purchases from the store without tripping an alarm. Looking again, at FIG. 2b, it can be seen that the field is stronger in the center of the configuration, and weaker at its edges. By orienting the coils appropriately, optimum advantage may be taken of the shape of the field. For example, if the coils are arranged so that they are aligned perpendicular to the direction in which a clerk is likely to sweep the item having a tag on it, the tag is more likely to pass through a strong part of the field. The deactivation system may, of course, be turned off completely such as when no one will be in the area to check out goods and deactivate the tags on merchandise.

While the coils in the figures have been typically shown as round, it should be understood that their shapes could take many forms. Depending on the shape of the area being covered and other factors, the coils could be square, triangular, etc. The magnetic field would still be quite capable of deactivating tags.

I claim:

1. A deactivator for an electronic article surveillance system comprising:
a) a retail counter featuring a deactivation surface;
b) first and second electrical coils formed of multiple windings of a wire embedded in said deactivator below said deactivation surface;
c) wherein said first electrical coil and said second electrical coils are arranged essentially coplanar, arranged sided-by-side, and arranged such that current flowing through said wire causes said first and second electrical coils to operate out of phase with each other;
d) wherein said first and second electrical coils generate a composite magnetic field above said deactivation surface that may be used to deactivate an electronic article surveillance marker, and
e) wherein said deactivation surface is comprised of a first portion and a second portion wherein the composite magnetic field is stronger in said first portion than the composite magnetic field in said second portion.

2. The deactivator for an electronic article surveillance system of claim 1 wherein said first and second electrical coils are arranged in series with each other electrically.

3. The deactivator for an electronic article surveillance system of claim 1 wherein the magnitude of the composite magnetic field may be altered.

4. The deactivator for an electronic article surveillance system of claim 1 wherein the deactivator system includes a monitoring means for monitoring the effectiveness of the deactivation cycle.

5. The deactivator of claim 4 wherein the magnitude of the composite magnetic field maybe altered as a function of said monitoring means.

6. The deactivator of claim 3 wherein the magnitude of the composite magnetic field may be altered as a result of changing the amount of electrical current in one or more of said electrical coils.

7. The deactivator of claim 4 wherein said monitoring means is comprised of a transceiver coil.

8. The deactivator of claim 1 wherein the number of windings in said first electrical coil and said second electrical coil are essentially the same.

9. The deactivator of claim 1, wherein:
the centers of said first coil and said second coil are on a line perpendicular to the direction in which a tag will typically be swept for deactivation.

10. The deactivator of claim 1, further comprising a powering means for supplying electrical current to said first and said second deactivation coils.

11. The deactivator of claim 10 further comprising a detecting means for detecting when an EAS sensor is in proximity to said deactivator, wherein said powering means cycles said deactivator coils to deactivate a tag detected in proximity to said deactivator.

12. The deactivator of claim 11, wherein said detecting means includes a means for determining whether a detected tag is deactivated after said deactivation coils are cycled.

13. The deactivator of claim 1 further comprising a third and fourth electrical coil, wherein said third and fourth electrical coils are electrically connected in series with each other and out of phase with each other.

14. The deactivator of claim 13 wherein said third and fourth electrical coils and further arranged such that the combination of said third and fourth electrical coils are electrically in parallel with said first and second electrical coils.
